(19) United States
(12) Patent Application Publication
(10) Pub. No.: US 2004/0026159 A1
(43) Pub. Date: Feb. 12, 2004

(54) Steering booster for steering system, especially the steering system of a motor vehicle

(76) Inventor: Konstantino Gerolimatos, Leonberg (DE)

Correspondence Address: OSTROLENK FABER GERB & SOFFEN, 1180 AVENUE OF THE AMERICAS, NEW YORK, NY, 100368403

(21) Appl. No.: 10/399,986

(22) PCT Filed: Oct. 23, 2001
(86) PCT No.: PCT/DE01/03973

(30) Foreign Application Priority Data
Oct. 23, 2000 (DE) 10052537.7

(51) Int. Cl. B62D 5/04

(52) U.S. Cl. 180/443

(57) ABSTRACT

A device acting as a steering booster for a steering system having a steering member which can rotate about an axis of rotation. The device includes a steering booster element that is rotatable in a radially external position with respect to the axis of rotation, the steering booster element being formed in a substantially flat manner perpendicular to the axis of rotation. The steering booster element being magnetically maintained on the steering system.

The present invention relates to a device as defined in the preamble of claim 1.

Steering boosters comprising a rotatably seated knob (rotary knob), which is formed as a handle element and is arranged in a radially external position on a steering member, for example a steering wheel, have been known before. Such a rotary knob permits the steering member to be moved with one hand. Handling of the rotary knob is mostly facilitated by an outer non-slip coating, such as a rubber coating, provided on the handle member.

The known steering boosters are connected with the disadvantage that the rotatably seated mount of the rotary knob is subjected to high transverse or shearing forces in use, with the result that the bearing play increases progressively and that the handle member, together with the bearing, must be exchanged from time to time.

In addition, the handle member presents a considerably risk of injury in case of a rear end collision.

Further, it is a disadvantage of the known steering boosters that removing the rotary knob, for example when the bearings get defective, is practically impossible. Consequently, worn or defective rotary knobs cannot be replaced without difficulty.

Now, it is the object of the present invention to improve a steering booster of the before-mentioned kind so that the disadvantages described above will be avoided. It is the intention to make the steering booster easily exchangeable and its production as easy and cost-effective as possible.

This object is achieved by the features defined in the independent claims. Further developments are the subject-matter of the sub-claims.

The particular shape of the steering booster element guarantees that the element projects only a short way from the steering member whereby the risk of injury mentioned above is minimized. Preferably, the surface of the steering booster element has a design similar to a spherical cup. The steering booster element fits into the outer shape of the steering member in a aesthetically satisfactory way and is almost invisible. The flat design further effectively prevents any risk of the steering booster element being easily disengaged from the steering member although it is held thereon only magnetically. Due to the fact that the steering booster element is held magnetically it can be exchanged easily and rapidly.

The device is especially well suited for use as a parking aid for heavy-moving vehicles, such as motor trucks.

According to a preferred embodiment, the magnetic mount is combined with a ball or roller bearing in order to permit rotation of the steering booster element on the steering member with the least possible friction. The magnetic mount then guarantees that the bearing play will not be increased beyond the necessary degree even after longer use because any increase in play will be compensated by the magnetic force which simply reduces the distance between the steering booster element and the bearing member without impairing the function of the bearing. It should be noted in this connection that the device according to the invention can be used with particular advantage in vehicles with power assisted steering as in this case the driver's ball of the thumb, resting on the steering booster element, can provoke a noticeable rotation of the steering member with only little effort. Further, it should be noted that in addition to the preferred use in motor trucks the invention can be used with advantage also in passenger cars, watercraft, aircraft, or the like.

The invention will be described hereafter with reference to one embodiment illustrated in the drawings, in which:

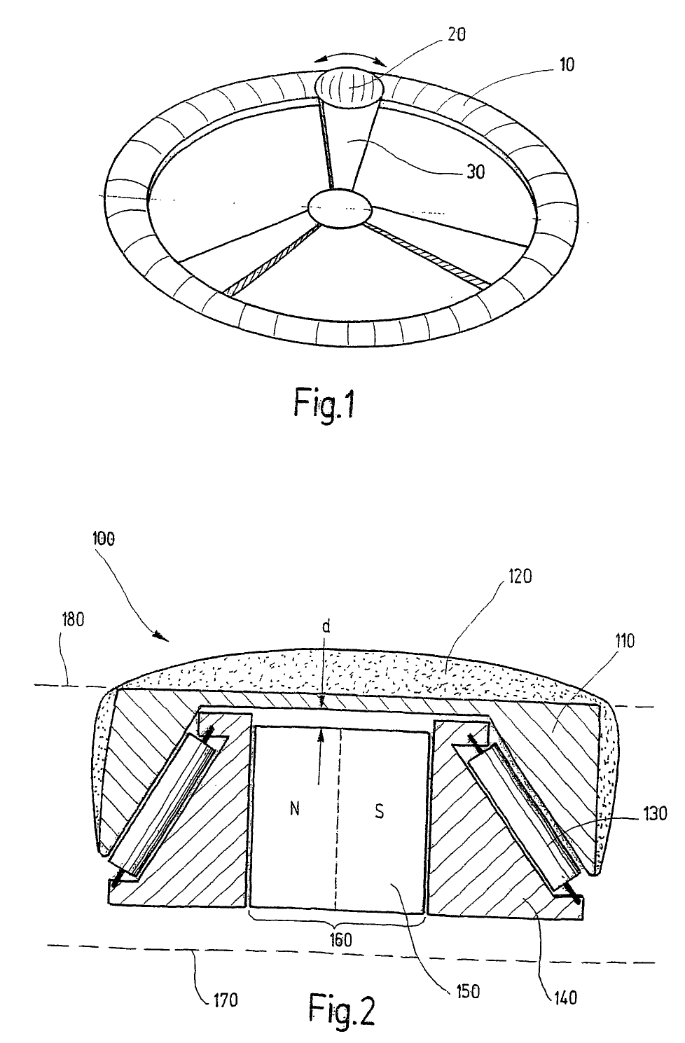

FIG. 1 shows a perspective view of a motor vehicle steering wheel comprising a steering booster (rotary knob) according to the invention; and

FIG. 2 shows a sectioned side view of a steering booster according to the invention in mounted condition.

The steering member illustrated in FIG. 1 comprises a steering booster 20 mounted on the upper surface of a steering wheel 10. For stability reasons, the steering booster 20 is arranged at the level of a steering-wheel spoke 30. It goes without saying that the steering booster 20 may be mounted in any position on the steering wheel 10 or even on one of the spokes 30.

The steering booster 100 illustrated in FIG. 2 comprises a steering booster element (rotary knob) 110, 120 which consists of a flange portion 110, made of a magnetisable material, and of a rubber coating 120 applied onto the surface of the first flange portion 110. The first flange portion 110 engages a roller bearing formed by tilted rollers 130 arranged in a circle. The rollers 130 are rotatably held in a second flange portion 140. A magnet 150 of circular shape, extending perpendicularly with respect to the paper plane, engages a passage opening 160 of the second flange portion and is fixed therein by bonding, pressing or in similar fashion.

According to a particularly advantageous mounting system, the magnet 150, or an element holding the magnet, engages a receiving element fitted tightly in the steering wheel 10 and fixed therein, for example, by means of a grub screw passed radially through the steering wheel 10. It is understood that in this case the magnet 150, or the element holding the magnet, will not end flush with the second flange 140—as shown in FIG. 2—but will extend axially beyond the latter so as to be able to engage the receiving element (not shown) in the steering wheel 10. When mounted in this way, the steering booster 100 can be removed as one unit.

The distance d formed in the mounted condition between the upper edge of the magnet 150 and the lower edge of the first flange element 110 is, preferably, smaller than 0.5 mm. That distance ensures that any play that may occur between the roller bearing 130 and the first flange element 110 will be largely balanced out by the magnetic forces of attraction. The broken lines 170, 180 indicate the outer dimensions of the steering wheel 10 shown in FIG. 1 in its mounted condition. As can be seen, it is only the rubber coating 120 of the steering booster or of the first flange element 110 that projects beyond the surface of the steering wheel. It should be noted that in the simplest of all embodiments the steering booster element can be magnetically held directly on the steering member without the use of a bearing and can be guided in this case, for example, in a recessed groove or the like.

1. Device acting as a steering booster for a steering system, especially the steering system of a motor vehicle, which can rotate about an axis of rotation, comprising a steering booster element (20, 110, 120) which can rotate in a radially external position with respect to the axis of rotation, characterised in that the steering booster element is embodied in a substantially flat manner perpendicular to the axis of rotation and is magnetically (150) maintained (130) on the steering system.

2. The device as defined in claim 1, characterised by a bearing member (130, 140), mounted firmly on the steering member, on which the steering booster element (20, 110, 120) is magnetically held.

3. The device as defined in claim 2, characterised in that the bearing member is configured as a roller bearing.

4. The device as defined in claim 3, characterised in that the roller bearing is formed by rollers (130), which are arranged in the form of a ring and aligned one with the other on their inner ends facing the steering booster element (20, 110, 120), and that the steering booster element can be fitted on the rollers in form-fit fashion.

5. The device as defined in any of the preceding claims, characterised in that a magnet (150) is arranged to centrally engage the bearing member (130, 140).

6. The device as defined in claim 5, characterised in that the magnet (150) or an element bearing the magnet (150) can be detachably mounted, in a manner substantially perpendicular to the axis of rotation and in form-fit fashion, in a receiving element mounted in the steering member and configured to be complementary to the magnet (150) or to the element carrying the magnet (150).

7. The device as defined in claim 6, characterised in that the magnet (150), or the element carrying the magnet, is a cylinder that engages the receiving element, which is configured as a circular ring, and that can be detachably mounted by means of a pin-like fastening element, especially a fastening element configured as a screw, that passes the steering member in a substantially radial direction.

8. The device as defined in any of claims 5 to 7, characterised in that the outer dimensions of the magnet (150) are adapted to the inner dimensions of a passage opening (160) of the bearing member (130, 140) and that the magnet is firmly connected with the bearing member by bonding, pressing or the like.

9. The device as defined in any of the preceding claims, characterised in that the clear distance (d) between the magnet and the lower edge of the steering booster element is smaller than 1 mm, preferably smaller than 0.5 mm.

10. The device as defined in any of the preceding claims, characterised in that the outer surface of the steering booster element is configured as a cup, especially a spherical cup.

11. The device as defined in any of the preceding claims, characterised in that the steering booster element is configured as a rotary knob.

12. Steering member, especially a steering member of a motor vehicle, comprising a device as defined in any of the preceding claims.
